(19) United States
(12) Patent Application Publication
(10) Pub. No.: US 2010/0091840 A1
(43) Pub. Date: Apr. 15, 2010

(54) VIDEO ENCODING METHOD AND VIDEO DECODING METHOD FOR ENABLING BIT DEPTH SCALABILITY

(75) Inventors: Yong Ying Gao, Beijing (CN); Yu Wen Wu, Beijing (CN)

Correspondence Address: Robert D. Shedd, Patent Operations;THOMSON Licensing LLC, P.O. Box 5312, Princeton, NJ, 08543-5312, US

(73) Assignee: Thomson Licensing Corporation

(21) Appl. No.: 12/448,783

(22) PCT Filed: Jan. 10, 2007
(86) PCT No.: PCT/CN2007/000105

§ 371 Date: Jul. 7, 2009

(51) Int. Cl. H04N 7/26

(52) U.S. Cl. 375/240.2; 375/240.25; 375/E07.211

(57) ABSTRACT

The invention presents a scalable solution to encode the whole 12-bit raw video once to generate one bitstream that contains an H.264/AVC compatible base layer and a scalable enhancement layer. If a color bit depth scalable decoder is available at the client end, both the base layer and the enhancement layer sub-bitstreams will be decoded to obtain the 12-bit video and it can be viewed on a high quality display that supports more than eight bit; otherwise only the base layer sub-bitstream is decoded using an H.264/AVC decoder and the decoded 8-bit video can be viewed on a conventional 8-bit display. The enhancement layer contains a residual based on a prediction from the base layer, which is either based on bit-shift or based on an advanced bit depth prediction is utilized, wherein the advanced bit depth prediction method is a Smoothed Histogram method or a Localized Polynomial Approximation method.

### FIELD OF THIS INVENTION

This invention relates to the technical field of digital video coding. It presents a technical solution for a novel type of scalability: bit depth scalability. New syntax elements and semantics are presented to be added to support bit depth scalability.

### BACKGROUND OF THE INVENTION

In recent years, higher bit color depth rather than the conventional eight bit color depth is more and more desirable in many fields, such as scientific imaging, digital cinema, high-quality-video-enabled computer games, and professional studio and home theatre related applications. Accordingly, the state-of-the-art video coding standard—H.264/AVC—has already included Fidelity Range Extensions, which support up to 14 bits per sample and up to 4:4:4 chroma sampling.

However, none of the existing high bit coding solutions supports color bit depth scalability. Assume that we have a scenario with 2 different decoders (or clients with different requests for the color bit depth, e.g. 12 bit) for the same raw video. The existing H.264/AVC solution is to encoder the 12-bit raw video to generate bitstream no. 1 and then convert the 12-bit raw video to an 8-bit raw video and encode the 8-bit counterpart to generate bitstream no. 2. If we want to deliver the video to different clients that request different bit depths, we have to deliver it twice, or put the 2 bitstreams in one disk together. It is of low efficiency regarding both the compression ratio and the operational complexity.

### SUMMARY OF THE INVENTION

This invention presents a technical solution to encode in a scalable manner the whole 12-bit raw video once to generate one bitstream that contains an H.264/AVC compatible base layer (BL) and a scalable enhancement layer (EL). If an H.264/AVC decoder is available at the client end, only the base layer sub-bitstream is decoded and the decoded 8-bit video can be viewed on a conventional 8-bit display device; if the color bit depth scalable decoder is available at the client end, both the BL and the EL sub-bitstreams will be decoded to obtain the 12-bit video and it can be viewed on a high quality display device that supports more than eight bit.

According to one aspect of the invention, one or more new syntax elements allow to signal whether inter-layer prediction for bit depth scalability shall be invoked, and if so then whether the operation of bit-shift is utilized as the bit depth inter-layer prediction or an advanced bit depth prediction is utilized as the bit depth inter-layer prediction, wherein the advanced bit depth prediction methods comprise at least one of the localized polynomial approximation method or the smoothed histogram method.

### BRIEF DESCRIPTION OF THE DRAWINGS

FIG. 1 illustrates a framework of bit depth scalable coding.

### DETAILED DESCRIPTION OF THE PREFERRED EMBODIMENT

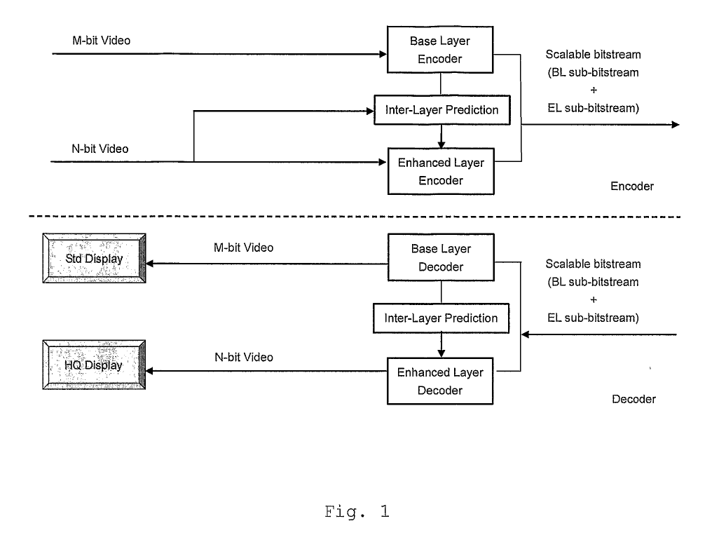

The framework of the presented color bit depth scalable coding is shown in FIG. 1. In FIG. 1, two videos will be used as an input to the video codec: N-bit raw video and M-bit (usually 8-bit) video (N>M). The M-bit video can be either converted from the N-bit raw video or given by other ways.

The M-bit video is encoded as the BL using the inside H.264/AVC encoder. The N-bit video is encoded as the EL using the scalable encoder. The coding efficiency of the EL can be significantly improved by utilizing the information of the BL. We call the utilization of the BL information in encoding the EL inter-layer prediction. Each picture—a group of macroblocks (MBs)—will have two access units, one for the BL and the other one for the EL. The coded bitstreams will be multiplexed to form a scalable bitstream.

During the decoding process, BL decoder will use only the BL sub-bitstream which is extracted from the whole bitstream, to provide a M-bit reconstructed video. By decoding the whole bitstream, N-bit video can be reconstructed.

In the following embodiment, we present a technical solution to color bit depth scalability. Two new syntax elements are added to the SVC sequence parameter set (SPS) in SVC extension (seq_parameter_set_svc_extension( ) to support color bit depth scalability: bit_depth_scalability_flag in line 13 of Tab.1 and bit_depth_pred_idc in line 15 of Tab.1.

TABLE 1
Two new syntax elements added to the sequence parameter
set SVC extension syntax

| 1 | seq_parameter_set_svc_extension( ) { | C | Descriptor |
|---|---|---|---|
| 2 | extended_spatial_scalability | 0 | u(2) |
| 3 | if ( chroma_format_idc > 0 ) { | | |
| 4 | chroma_phase_x_plus1 | 0 | u(2) |
| 5 | chroma_phase_y_plus1 | 0 | u(2) |
| 6 | } | | |
| 7 | if( extended_spatial_scalability == 1 ) { | | |
| 8 | scaled_base_left_offset | 0 | se(v) |
| 9 | scaled_base_top_offset | 0 | se(v) |
| 10 | scaled_base_right_offset | 0 | se(v) |
| 11 | scaled_base_bottom_offset | 0 | se(v) |
| 12 | } | | |
| 13 | bit_depth_scalability_flag | 0 | u(1) |
| 14 | if ( bit_depth_scalability_flag ) { | | |
| 15 | bit_depth_pred_idc | 0 | ue(v) |
| 16 | } | | |
| 17 | fgs_coding_mode | 2 | u(1) |
| 18 | if( fgs_coding_mode == 0 ) { | | |
| 19 | groupingSizeMinus1 | 2 | ue(v) |
| 20 | } else { | | |
| 21 | numPosVector = 0 | | |
| 22 | do { | | |
| 23 | if( numPosVector == 0 ) { | | |
| 24 | scanIndex0 | 2 | ue(V) |
| 25 | } | | |
| 26 | else { | | |
| 27 | deltaScanIndexMinus1[numPosVector] | 2 | ue(v) |
| 28 | } | | |
| 29 | numPosVector ++ | | |
| 30 | } while( scanPosVectLuma[ | | |
| | numPosVector − 1 ] < 15 ) | | |
| 31 | } | | |
| 32 | } | | |

Exemplarily, bit_depth_scalability_flag equal to 1 specifies that process of color bit depth prediction shall be invoked in the inter-layer prediction. Otherwise (equal to 0) specified that no process of color bit depth prediction shall be invoked (this may be used as default).

bit_depth_pred_idc equal to 0 specifies that the operation of bit-shift is utilized as the color bit depth inter-layer prediction (this may be used as default). Otherwise is reserved for advanced color bit depth prediction, as described below.

Another illustrative embodiment of the technical solution to enable bit depth scalability within the framework of SVC is shown in the following. Only one new syntax element is added to the sequence parameter set (SPS) SVC extension syntax (seq_parameter_set_svc_extension( )) to support bit depth scalability: bit_depth_pred_idc_plus1, as shown in line 13 of Table 2.

TABLE 2
New syntax element (in line 13) added to the sequence
parameter set SVC extension syntax

| 1 | seq_parameter_set_svc_extension( ) { | C | Descriptor |
|---|---|---|---|
| 2 | extended_spatial_scalability | 0 | u(2) |
| 3 | if ( chroma_format_idc > 0 ) { | | |
| 4 | chroma_phase_x_plus1 | 0 | u(2) |
| 5 | chroma_phase_y_plus1 | 0 | u(2) |
| 6 | } | | |
| 7 | if( extended_spatial_scalability == 1 ) { | | |
| 8 | scaled_base_left_offset | 0 | se(v) |
| 9 | scaled_base_top_offset | 0 | se(v) |
| 10 | scaled_base_right_offset | 0 | se(v) |
| 11 | scaled_base_bottom_offset | 0 | se(v) |
| 12 | } | | |
| 13 | bit_depth_pred_idc_plus1 | 0 | ue(v) |
| 14 | fgs_coding_mode | 2 | u(1) |
| 15 | if( fgs_coding_mode == 0 ) { | | |
| 16 | groupingSizeMinus1 | 2 | ue(v) |
| 17 | } else { | | |
| 18 | numPosVector = 0 | | |
| 19 | do { | | |
| 20 | if( numPosVector == 0 ) { | | |
| 21 | scanIndex0 | 2 | ue(V) |
| 22 | } | | |
| 23 | else { | | |
| 24 | deltaScanIndexMinus1[numPosVector] | 2 | ue(v) |
| 25 | } | | |
| 26 | numPosVector ++ | | |
| 27 | } while( scanPosVectLuma[ | | |
| | numPosVector − 1 ] < 15 ) | | |
| 28 | } | | |
| 29 | } | | |

In this example, bit_depth_pred_idc_plus1 equal to 0 specifies that no process of bit depth prediction shall be invoked in the inter-layer prediction (default). Other values of bit_depth_pred_idc_plus1 being greater than 0 specify the process of bit depth prediction in the inter-layer prediction (i.e. which prediction process is to be used).

In both, encoding and decoding processing, the intra texture upsampling procedure and the conventional inter texture (residual) upsampling invokes the (same) bit depth prediction procedure.

According to one aspect of the invention, a video encoding method comprises steps of

adding a first flag to indicate whether the process of bit depth scalable coding shall be invoked to the bitstream,
adding a second flag to specify the prediction approach that is described below to the bitstream,
conducting the specified prediction approach to obtain the predicted version of the high bit depth input from the reconstructed version of the low bit depth input (base layer or lower enhancement layers), and
encoding the residual between the original version and predicted version of the high bit depth input as the enhancement layer.

An additional optional step is adding supplemental information for the specified prediction approach to the bitstream.

According to another aspect of the invention, a video decoding method comprises steps of

reconstructing lower layer video (BL or lower EL),
receiving a first flag and a second flag from the bitstream, determining from the first flag that the process of bit depth scalable coding shall be invoked,
determining from the second flag which bit depth prediction approach is to be used, wherein possible bit depth prediction approaches are bit shift and at least one of Smoothed Histogram and Localized Polynomial Approximation,
conducting the determined prediction approach to obtain a predicted version of the high bit depth input from the reconstructed version of the low bit depth input,
decoding the residual between the original version and predicted version of the high bit depth input from the enhancement layer bitstream, and
reconstructing the high bit depth input in terms of the predicted version of the high bit depth input and the residual between the original version and predicted version of the high bit depth input.

Bit shift means that one or more additional bits are appended to a value, with the most significant bit (MSB) remaining the MSB:

Vₚ=V_{b}2^{N-8}+2^{N-9}

where V_{b} is a sample of the BL reconstruction picture and Vₚ is the corresponding sample of the predicted N-bit video. If Vₑ is a sample of the reconstructed EL and V, is the residual value then

Vₑ=Vₚ+Vᵣ

E.g., if the 12-bit value is 1101_{—}0100_{—}0110, then the BL value is 1101_{—}0100 and the residual is 1110:
V_{b}=1101_{—}0100 (BL value)
Vₚ=1101_{—}0100_{—}1000 (prediction/reconstruction)
V_{d}=1101_{—}0100_{—}0110−1101_{—}0100_{—}1000=1110 (residual)
V_{d} will be encoded, and when it is reconstructed it is Vᵣ.

The purpose of adding 2^{N-9} is to use the median value, rather than the minimum or maximum value between V_{b}*2^{N-8} and (V_{b}+1)*2^{N-8}. In general, high color bit-depth uses N bits and standard color bit-depth uses M bits (M<N). The prediction/reconstruction value then has N bits, and the difference value (i.e. the residual) has N-M bits.

An optional step is to obtain supplemental information for the specified prediction approach from the bitstream.

In one embodiment, two new syntax elements are added to the sequence parameter set SVC extension syntax of the H.264/AVC to support bit depth scalability, wherein the conventional SVC intra texture upsampling procedure and the inter texture (residual) upsampling is modified to invoke the bit depth prediction procedure.

In one embodiment, only one new syntax element is added to the sequence parameter set SVC extension syntax of the H.264/AVC to support bit depth scalability and the intra texture upsampling procedure.

At least one of the advanced bit depth prediction methods is either the Smoothed Histogram method, or the Localized Polynomial Approximation method, as defined below.

### Smoothed Histogram

This advanced bit depth prediction method comprises for encoding the following steps: generating a transfer function, e.g. in the form of a look-up table (LUT), which is suitable for mapping input color values to output color values, both consisting of 2^{M} different colors, applying the transfer function to a first video picture with low or conventional color bit-depth, generating a difference picture or residual between the transferred video picture and a second video picture with higher color bit-depth (N bit, with N>M; but may be same spatial resolution as the first video picture) and encoding the residual. Then, the encoded first video picture, parameters of the transfer function (e.g. the LUT itself) and the encoded residual are transmitted to a receiver. The parameters of the transfer function may also be encoded and transmitted. Further, the parameters of the transfer function are indicated as such.

In particular, the transfer function may be obtained by comparing color histograms of the first and the second video pictures, for which purpose the color histogram of the first picture, which has 2^{M} bins, is transformed into a “smoothed” color histogram with 2^{N} bins (N>M), and determining a transfer function from the smoothed histogram and the color enhancement layer histogram which defines a transfer between the values of the smoothed color histogram and the values of the color enhancement layer histogram. The described procedure is done separately for the basic display colors e.g. red, green, blue.

A method for decoding for this aspect of the invention comprises extracting from a bit stream video data for a first and a second video image and extracting color enhancement control data, furthermore decoding and reconstructing the first video image, wherein a reconstructed first video image is obtained having color pixel values with M bit each, and constructing from the color enhancement control data a mapping table that implements a transfer function. Then the mapping table is applied to each of the pixels of the reconstructed first video image, and the resulting transferred video image serves as prediction image which is then updated with the decoded second video image. The decoded second video image is a residual image, and the updating results in an enhanced video image which has pixel values with N bit each (N>M), and therefore a higher color space than the reconstructed first video image.

The above steps are performed separately for each of the basic video colors e.g. red, green and blue. Thus, a complete video signal may comprise for each picture an encoded low color-resolution image, and for each of these colors an encoded residual image and parameters of a transfer function, both for generating a higher color-resolution image. Advantageously, generating the transfer function and the residual image is performed on the R-G-B values of the raw video image, and is therefore independent from the further video encoding. Thus, the low color-resolution image can then be encoded using any conventional encoding, e.g. according to an MPEG or JVT standard (AVC, SVC etc.). Also on the decoding side the color enhancement is performed on top of the conventional decoding, and therefore independent from its encoding format.

Details of the Smoothed Histogram approach are disclosed in the International patent application PCT/CN2006/001699.

### Localized Polynomial Approximation

According to this aspect of the invention; a spatially localized approach for bit depth prediction by polynomial approximation is employed. Two video sequences are considered that describe the same scene and contain the same number of frames. Two frames that come from the two sequences respectively and have the same picture order count (POC), i.e. the same time stamp, are called a “synchronized frame pair” herein. For each synchronized frame pair, the corresponding/collocated pixels (meaning two pixels that belong to the two frames respectively but have the same coordinates in the image coordinate system) refer to the same scene location or real-world location. The only difference between the corresponding pixels is the color bit depth, corresponding to color resolution. PSNR may be used as difference measurement between pictures, e.g. original and encoded picture.

A corresponding method for encoding a first color layer of a video image, wherein the first color layer comprises pixels of a given color and each of the pixels has a color value of a first depth, comprises the steps of

generating or receiving a second color layer of the video image, wherein the second color layer comprises pixels of said given color and each of the pixels has a color value of a second depth being less than the first depth, dividing the first color layer into first blocks and the second color layer into second blocks, wherein the first blocks have the same number of pixels as the second blocks and the same position within their respective image, determining for a first block of the first color layer a corresponding second block of the second color layer, transforming the values of pixels of the second block into the values of pixels of a third block using a linear transform function that minimizes the difference between the first block and the predicted third block,
calculating the difference between the predicted third block and the first block, and encoding the second block, the coefficients of the linear transform function and said difference.

All pixels of a block may use the same transform, while the transform may be individual for each pair of a first block and its corresponding second block.

In one embodiment, a pixel at a position u,v in the first block is obtained from the corresponding pixel at the same position in the second block according to

BN_{i,l}(u,v)=(BM_{i,l}(u,v))ⁿcₙ+(BM_{i,l}(u,v))ⁿ⁻¹cₙ₋₁+ . . . +(BM_{i,l}(u,v))^{1/m}c_{1/m}+c₀

with the coefficients being cₙ, cₙ₋₁, . . . c₀.

The linear transform function may be determined by the least square fit method. The method may further comprise the steps of formatting the coefficients as metadata, and transmitting said metadata attached to the encoded second block and said difference.

For this aspect of the invention, a method for decoding a first color layer of a video image, wherein the first color layer comprises pixels of a given color and each of the pixels has a color value of a first depth, comprises the steps of decoding a second color layer of the video image, wherein the second color layer comprises pixels of said given color and each of the pixels has a color value of a second depth being less than the first depth, decoding coefficients of a linear transform function, decoding a residual block or image, applying the transform function having said decoded coefficients to the decoded second color layer of the video image, wherein a predicted first color layer of the video image is obtained, and updating the predicted first color layer of the video image with the residual block or image.

More details of the Localized Polynomial Approximation approach are disclosed in the International patent application PCT/CN2006/002593.

The invention presents a scalable solution to encode the whole 12-bit raw video once to generate one bitstream that contains an H.264/AVC compatible base layer and a scalable enhancement layer. If a color bit depth scalable decoder is available at the client end, both the base layer and the enhancement layer sub-bitstreams will be decoded to obtain the 12-bit video and it can be viewed on a high quality display that supports more than eight bit; otherwise only the base layer sub-bitstream is decoded using an H.264/AVC decoder and the decoded 8-bit video can be viewed on a conventional 8-bit display. The enhancement layer contains a residual based on a prediction from the base layer, which is either based on bit-shift or based on an advanced bit depth prediction is utilized, wherein the advanced bit depth prediction method is a Smoothed Histogram method or a Localized Polynomial Approximation method.

1-9. (canceled)

10. A method for encoding video data in a bit depth scalable manner, wherein an enhancement layer video is predicted from a reconstructed base layer video, and wherein at least one indication is added to the data to define the process of bit depth scalability, wherein
if the indication has a first value, no bit depth inter-layer prediction is utilized;
if the indication has a second value, it specifies that bit depth inter-layer prediction based on bit-shift is utilized; and
if the indication has another than the first or second value, bit depth inter-layer prediction based on an advanced bit depth prediction is utilized, wherein said advanced bit depth prediction method is a Smoothed Histogram method or a Localized Polynomial Approximation method.

11. The method according to claim 10, wherein the Smoothed Histogram method comprises the following steps:
generating a transfer function suitable for mapping input color values to output color values;
applying the transfer function to a first video picture with low or conventional color bit-depth;
generating a difference picture or residual between the transferred video picture and a second video picture with higher color bit-depth (N bit, with N>M); and
encoding the residual.

12. The method according to claim 11, wherein the transfer function is obtained by comparing color histograms of the first and the second video pictures, for which purpose the color histogram of the first picture having 2^{M} bins is transformed into a smoothed color histogram having 2^{N} bins with N>M, and determining a transfer function from the smoothed histogram and the color enhancement layer histogram, which transfer function defines a transfer between the values of the smoothed color histogram and the values of the color enhancement layer histogram.

13. The method according to claim 11, wherein the steps are performed separately for the basic display colors.

14. The method according to claim 10, wherein the Localized Polynomial Approximation method is a method for encoding a first color layer of a video image, wherein the first color layer comprises pixels of a given color and each of the pixels has a color value of a first depth, comprises the steps of
generating or receiving a second color layer of the video image, wherein the second color layer comprises pixels of said given color and each of the pixels has a color value of a second depth being less than the first depth;
dividing the first color layer into first blocks and the second color layer into second blocks, wherein the first blocks have the same number of pixels as the second blocks and the same position within their respective image;
determining for a first block of the first color layer a corresponding second block of the second color layer;
transforming the values of pixels of the second block into the values of pixels of a third block using a linear transform function that minimizes the difference between the first block and the predicted third block;
calculating the difference between the predicted third block and the first block; and
encoding the second block, the coefficients of the linear transform function and said difference.

15. A method for decoding bit depth scalable video data comprising the steps of
extracting at least one indication from encoded video data, the indication being indicative of a process of bit depth scalability;
decoding the video according to the indication, wherein
if the indication has a first value, then bit depth inter-layer prediction is not utilized;
if the indication has a second value, bit depth inter-layer prediction based on bit-shift is utilized; and
if the indication has another than said first or second value, then bit depth inter-layer prediction based on an advanced bit depth prediction is utilized, wherein said advanced bit depth prediction method is a Smoothed Histogram method or a Localized Polynomial Approximation method.

16. The method according to claim 10, wherein the indication comprises two separate flags.

17. A device for encoding video data, comprising
means for encoding a video base layer;
means for encoding a video enhancement layer, comprising first and second means for generating a bit depth inter-layer prediction from the base layer, wherein the first means for generating a bit depth inter-layer prediction uses bit-shift and the second means for generating a bit depth inter-layer prediction uses at least one of a Smoothed Histogram method and a Localized Polynomial Approximation method; and
means for adding at least one indication to the data to define the utilized method for performing bit depth inter-layer prediction, wherein
if no bit depth inter-layer prediction is utilized the indication has a first value, if bit-shift is utilized the indication has a second value; and
if bit depth inter-layer prediction based on an advanced bit depth prediction is utilized, the indication has another than the first or second value, wherein said advanced bit depth prediction method is a Smoothed Histogram method or a Localized Polynomial Approximation method.

18. A device for decoding video data, comprising
means for decoding a video base layer;
means for decoding a video enhancement layer, comprising first and second means for generating a bit depth inter-layer prediction from the decoded base layer, wherein the first means for generating a bit depth inter-layer prediction uses bit-shift and the second means for generating a bit depth inter-layer prediction uses at least one of a Smoothed Histogram method and a Localized Polynomial Approximation method; and
means for extracting at least one indication from the encoded video data, the indication defining the utilized method for performing bit depth inter-layer prediction, wherein
if the indication has a first value then no bit depth inter-layer prediction is utilized,
if the indication has a second value then bit-shift is utilized; and
if the indication has another than the first or second value, bit depth inter-layer prediction based on an advanced bit depth prediction is utilized, wherein said advanced bit depth prediction method is a Smoothed Histogram method or a Localized Polynomial Approximation method.

19. A device according to claim 17, wherein the indication comprises two separate flags.
